(19) United States
(12) Patent Application Publication
(10) Pub. No.: US 2011/0241520 A1
(43) Pub. Date: Oct. 6, 2011

(54) HALOGEN INCANDESCENT LAMP

(75) Inventors: Albert Fieger, Nennslingen (DE); Thomas Heil, Schernfeld (DE); Heinz Lang, Schernfeld (DE); Georg Rosenbauer, Wassertruedingen (DE); Roland Stark, Wellheim (DE)

(73) Assignee: OSRAM GESELLSCHAFT MIT BESCHRAENKTER HAFTUNG, Muenchen (DE)

(21) Appl. No.: 13/072,814

(22) Filed: Mar. 28, 2011

(30) Foreign Application Priority Data
Apr. 1, 2010 (DE) 10 2010 003 630.7

(51) Int. Cl. H01K 1/26; H01K 1/50; H01K 1/54

(52) U.S. Cl. 313/113; 313/579; 313/557

(57) ABSTRACT

In various embodiments, a halogen incandescent lamp is provided. The halogen incandescent lamp may include a bulb, in which a light-emitting element is fixed by means of a frame, the bulb defining an axis, the frame having a frame wire and a separate part for holding the light-emitting element, wherein the separate part is a clip which is fastened on the frame wire, the clip having a functional limb, with the end of said functional limb being threaded or plugged into a coiled end of the light-emitting element.

### CROSS-REFERENCE TO RELATED APPLICATION

This application claims priority to German Patent Application Serial No. 10 2010 003 630.7, which was filed Apr. 1, 2010, and is incorporated herein by reference in its entirety.

### TECHNICAL FIELD

Various embodiments are based on a halogen incandescent lamp. It is intended e.g. for operation on a medium voltage to a high voltage (HV) of typically from 80 to 250 V.

### BACKGROUND

DE-U 20 2009 009 008 and DE-A 10 2009 052 995 disclose a halogen incandescent lamp, in which the burner is pinch-sealed at one end for a mains voltage application. The light-emitting element is arranged centrally in the burner and held by means of a frame.

### SUMMARY

In various embodiments, a halogen incandescent lamp is provided. The halogen incandescent lamp may include a bulb, in which a light-emitting element is fixed by means of a frame, the bulb defining an axis, the frame having a frame wire and a separate part for holding the light-emitting element, wherein the separate part is a clip which is fastened on the frame wire, the clip having a functional limb, with the end of said functional limb being threaded or plugged into a coiled end of the light-emitting element.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a halogen incandescent lamp with an IRC coating using HV technology;

FIG. 2 shows the lamp shown in FIG. 1 in a perspective view;

FIG. 3 shows a detail showing the clip;

FIG. 4 shows a detail showing a filament loop;

FIG. 5 shows a detail showing an anchoring part;

FIG. 6 shows a detail showing the light-emitting element fixed on the base-side end.

### DETAILED DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments achieve improved holding of the frame within the bulb, whether it be in the exhaust tube and/or quartz bar and/or the pinch seal.

Furthermore, various embodiments achieve improved holding of the frame using a quartz bar and/or in the pinch seal.

In principle, various embodiments may be applied to halogen incandescent lamps with a base at one end operated on the mains voltage, with the intended application preferably being HV, but with an MV application not being ruled out. In this case, the bulb may be coated with IRC and has back-reflectance properties. For this purpose, the bulb is elliptical, cylindrical or shaped in the form of a barrel body, for example, with the light-emitting element being positioned in the central axis in order to intercept the back-reflected radiation.

According to various embodiments, a holding wire or frame holder may be used, which ensures the centering of the light-emitting element in the axis as well as possible, but without the efficiency of the lamp being impaired notably in the process. It is essential for this that the heat dissipation of the holding wire is reduced as much as possible.

This may be achieved by virtue of the fact that the holding wire does not directly hold the end of the light-emitting element. Instead, the holding wire may consist of two different parts, the actual frame wire, which is anchored in the bulb or the quartz bar or the pinched seal, and a clip, which connects the frame wire to that end of the light-emitting element which is remote from the pinch seal.

The clip may be formed in one part or even in two parts again. Various properties of the clip are as follows: the clip is substantially designed as a U-shaped, V-shaped or L-shaped hook. It may have two limbs and optionally a base. The first limb may be free. The second limb may be functional and may be threaded into the coiled end of the light-emitting element. This coiled end of the light-emitting element may be connected to the light-emitting part of the light-emitting element, e.g. via a section with a large pitch. Correspondingly, it may be advantageous if the diameter of the clip is selected to be independent of the diameter of the frame wire in such a way that it is matched internally to the diameter of the coiled end of the light-emitting element, with the result that the end of the light-emitting element may easily rest thereon. The functional end of the clip may be bent back and may be more than 10% longer than the free end of the clip. In various embodiments, the functional end consists of the limb base, which itself is already at least 5% longer than the free limb and is parallel to the first limb, and an attachment, which is bent back through approximately 90° with respect thereto. In various embodiments, the parts of the clip may be aligned in one plane.

The clip may be fastened on the frame wire at the height of the end of the light-emitting element, e.g. welded thereto at one or two points. The two points of contact may be arranged on a respective other limb.

The attachment may be so long that it protrudes beyond the end of the light-emitting element, with the result that the light-emitting element is securely anchored thereon. Advantageously, the distance by which it protrudes may be thickened, for example by means of a laser or the like, with the result that the end of the light-emitting element can no longer slide out unintentionally. Alternatively, the coil may be pressed on mechanically or welded by means of resistance welding. Another alternative for preventing the filament from sliding off may be that of embossing a wave into the functional end of the clip.

The material of the clip may be selected such that the clip at the same time acts as getter. In various embodiments, the material used may be tantalum.

The frame wire may then be selected with as small a diameter as possible, which minimizes shading as a result of the frame wire. This selection may not be possible in the case of an integral holding wire. A typical diameter may be from 0 2 mm to 0.6 mm. The reverse case is likewise possible, namely that the frame wire is relatively thick, for example 0.45 mm to 0.55 mm for a typical power range of from 20 W to 1000 W for reasons of standardization, with the inner coil being thinner by a factor of at least two in the case of the filament with the lowest wattage, for example having a thickness of only 0.2 mm.

This frame wire merely serves the purpose of transporting current. The holding function may be performed substantially by the clip. In this case, that end of the frame wire which is remote from the base may be a holder which is anchored separately in an exhaust tube.

The difference in diameter should not be so markedly pronounced between the clip and the end of the light-emitting element. The delta Δ between the diameter of the clip wire or its attachment anchored in the light-emitting element and the inner diameter of the filament at the end of the light-emitting body may be at most 300 μm in accordance with various embodiments.

In various embodiments, the frame wire and the clip may consist of different material, with only the clip needing to be manufactured from an expensive material acting as getter such as Ta or Nb.

The manufacture, e.g. the threading of the filament at the end of the light-emitting element, is much simpler in the case of the holder with the clip than in the case of an integral holding wire, since the anchoring in the exhaust tube does not interfere during the threading process. The production sequence may be as follows: first the end of the light-emitting element is threaded onto the short clip, then the clip is welded, e.g. by means of laser, to the frame wire. In addition, during the laser-welding of the clip to the threaded filament end, an adjustment of the light-emitting element may take place and therefore the filament end and thus the entire light-emitting element may be positioned more accurately on the frame.

Typically, the long frame wire may consist of or may include tungsten or at least of Mo or another material, which is similarly high-melting. In the case of a frame wire consisting of or including W, it may not be possible, as a result of the brittleness for bends to be provided with radii which are overly narrow, said overly narrow radii being required for the suspension and in particular the precise positioning of the filament end. This may be solved by the novel two-part holding wire by virtue of different materials or W alloys being used for the frame wire, on the one hand, and the clip, on the other hand.

The clip may be manufactured from an alloy of Ta, Nb or Mo or a combination thereof, which act as getter.

It is also possible for a W alloy or a Mo alloy, e.g. a tungsten-rhenium (W—Re) alloy or a Mo-lanthanum alloy, which is easily deformable and at the same time readily weldable, in comparison with pure W, to be used for the clip if the intention is or it is possible for the getter effect to be dispensed with. In this case, the end of the frame wire may be itself manufactured separately again, to be precise from a getter material such as Ta. The specific embodiment in this case is based on the temperature conditions during operation of the lamp. Since the holding clip is close to the filament, the temperature of at least 400° C. which is required for the effectiveness of the getter may be reached more easily than, for example, the getter which is typically applied to the frame or in the pinch seal.

In various embodiments, the bulb may be coated with IRC. The centering may further be favored by fixing the frame wire in the exhaust tube. In order not to destabilize the centering, it may be advantageous to fix the light-emitting element using one or more frame holders. This reduces the filament sag during the life of the lamp. In various embodiments, a quartz bar integrated in the pinch seal is also used for ensuring the orientation of the light-emitting element in the pinch seal and for nevertheless keeping the physical length short.

Overall, a halogen incandescent lamp may be aligned with high precision and having very high efficiency which is also maintained over a long life results.

A difference in size between the diameter of the light-emitting element and the diameter of the holding wire primarily occurs in the case of HV lamp types where the difference can be up to a factor of 3 or more, depending on the wattage.

The centering of the long frame wire which is provided in the exhaust tube makes it possible for the light-emitting element to be centered axially precisely. This may be important in the case of an axial light-emitting element, which is surrounded by an IRC-coated bulb.

In general, the long frame wire may be formed in two parts. Its end acts as the anchoring part, which is automatically centered in the exhaust tube of the bulb. The U-shaped end of the filament holder may in this case be in the form of a filament such that said filament bears internally in the exhaust tube. This may result in a passage for introducing a flushing tube for further treatment process for the lamp in the exhaust tube before said tube is fused off to form an exhaust tip. Owing to the filament-type fixing of the anchoring part, the light-emitting element may largely be fixed centered in the bulb depending on the tolerances of the wire diameter.

Various features of various embodiments are as follows:

A halogen incandescent lamp with a bulb, in which a light-emitting element is fixed by means of a frame, the bulb defining an axis, the frame having a frame wire and a separate part for holding the light-emitting element, wherein the separate part may be a clip which is fastened on the frame wire, the clip having a functional limb, with the end of said functional limb being threaded or plugged into a coiled end of the light-emitting element.

In various embodiments, the clip has two limbs, which are connected to one another via a bend, e.g. the two limbs spanning one plane. In various embodiments, the clip may be bent such that it is U-shaped, L-shaped or V-shaped.

In various embodiments, the end of the functional limb may be bent back as an attachment to the limb.

In various embodiments, the bulb may be coated with a reflective coating, e.g. IRC.

In various embodiments, the attachment protrudes beyond the end of the light-emitting element and e.g. has a thicker diameter.

In various embodiments, the clip may be fastened on the frame wire at two points.

In various embodiments, the clip may be manufactured from a material with getter effect, e.g. from a Ta-containing or Nb-containing material.

In various embodiments, the clip may be manufactured from a high-melting material, e.g. tungsten or molybdenum, which deforms more easily or has higher ductility than the frame wire. It may thus be possible for bends to be provided with narrower radii and fewer spring-back effects and wire breakages occur. The easier deformability may be brought about e.g. by annealing or by another material, for example a relatively expensive alloy such as W—Re.

In various embodiments, given different lamp powers, i.e. filament wattages, only the diameter of the clip may be matched to the inner diameter of the coiled end of the light-emitting element. The diameters of the remaining frame wires may remain the same, which enormously reduces the complexity and thus the costs given different lamp wattages.

In various embodiments, the frame wire may have a section which runs at an angle with respect to the axis and on which the clip is fastened.

In various embodiments, that end of the frame wire which is remote from the base may be formed from a separate part, which is anchored in the exhaust tip.

In various embodiments, the bulb coated with IRC may be provided with an envelope consisting of or including soft glass.

In various embodiments, the bulb may be provided with a base, such as a screw-in base or plug-in base.

In various embodiments, the bulb coated with IRC may be fixed in a ceramic holder.

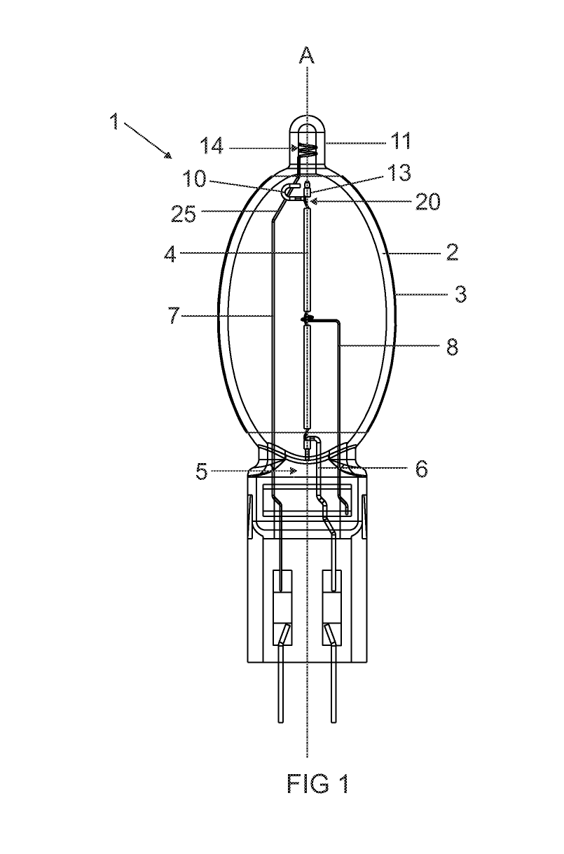

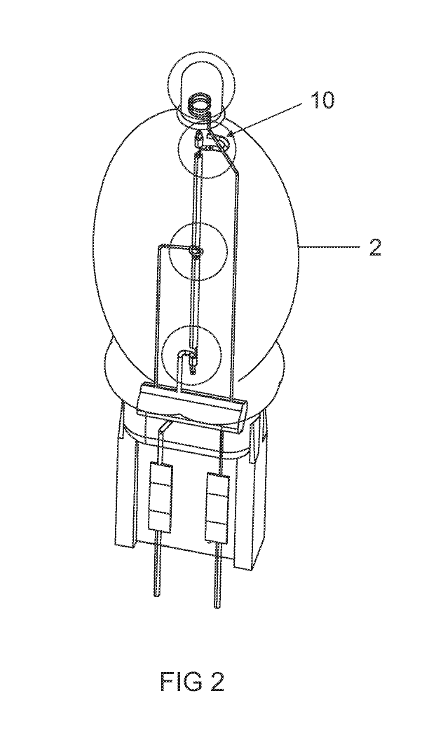

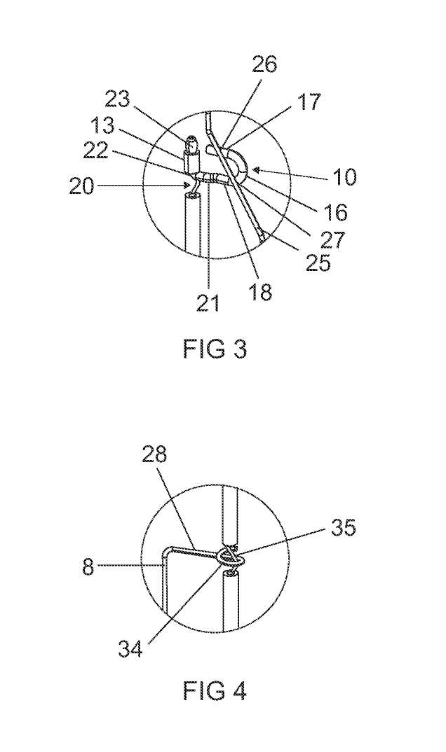

FIG. 1 shows a schematic of a novel halogen incandescent lamp 1 for a mains voltage of 230 V. The halogen incandescent lamp 1 has an elliptical bulb 2, which is coated (3) on the outside with IRC, as is known per se. A coiled light-emitting element 4 is situated in the lamp axis. The bulb 2 is filled with a halogen-containing fill, as is known per se.

A frame 5 for holding the light-emitting element has a short power supply line 6 and a long frame wire 7, which is guided along the light-emitting element. Both are manufactured from tungsten, but it is also possible in principle for Mo to be used. Furthermore, the frame also has a central filament holder 8, which is likewise guided parallel to the light-emitting element. The filament holder 8 holds a central region of the light-emitting element, wherein the central region is uncoiled or has a single coil and the light-emitting element has a double coil.

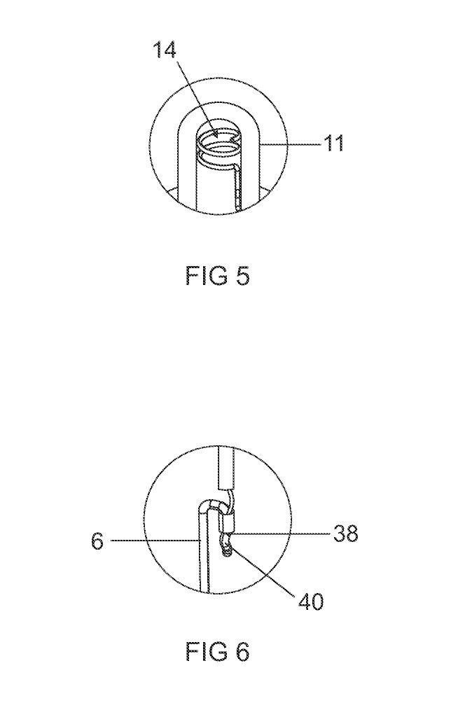

The end of the short power supply line 6 is bent back (see FIG. 6). The light-emitting element is arranged in the axis A of the lamp. The short power supply line 6 is bent back through approximately 180° C.

The long frame wire 7 is anchored in an exhaust tube 11 in the manner of a loop or coil (14). The frame wire does not have any direct connection to that end of the light-emitting element which is remote from the base, however.

That end 13 of the light-emitting element which is remote from the base has either a single or a double coil, while the light-emitting element 4 itself has a single coil (sc) or a double coil (cc). The end 13 of the light-emitting element is connected to the light-emitting part of the light-emitting element 4 via a skip coil 20, i.e. a turn with a very large pitch, which is at least five times as great as the pitch of the light-emitting part of the light-emitting body.

The connection between the frame wire and the end of the light-emitting element is produced via a special part 10, which can best be described as a clip. The clip 10 is in principle in the form of a V-shaped or U-shaped part, with a base 16 (optional) and in any case two limbs as essential parts. A first limb 17 is relatively short. A second limb 18 is at least 10% longer than the first limb 17. It can be bent at its end 21. It may be provided that it has means for fastening the end 13 of the light-emitting element. In various embodiments, the means is in the form of an attachment part 22, which is at approximately 90° with respect to the second limb 18, e.g. in the direction toward the first short limb, and e.g. lies in the plane covered by the two limbs 17, 18. The end of the attachment 22 is inserted into the coiled end 13 of the light-emitting element and e.g. protrudes out of said light-emitting element at the other end. In various embodiments, the protruding end of the attachment may be in this case fused to form a sphere 23, with the result that the end of the light-emitting element can no longer slide out of the attachment. A laser can be used for this purpose.

The frame wire 7 is guided parallel to the light-emitting element 4, but a section 25 thereof which is remote from the base is bent back at an angle and guided toward the exhaust tube 11. The clip 10 may be welded to this angled section 25 with two points of adhesion 26, 27, which lie in the plane of the clip. The material of the clip may have getter properties. In various embodiments, Ta or Nb, possibly as an alloy, is suitable for this purpose.

FIG. 4 shows a detail of the additional filament holder 8. That end 28 of said filament holder which is bent back and is directed toward the light-emitting element is bent to form an open loop 34, which loosely surrounds a central part 35 of the light-emitting element, which does not emit light.

FIG. 5 shows that end 14 of the frame wire which is remote from the base. It is bent, possibly as a separate part, to form from 1.5 to 3 turns which are spaced apart from one another. Said turns are matched to the inner diameter of the exhaust tube 11 and center the frame wire 7 or the end 14 thereof.

Finally, FIG. 6 shows a detail of the end of the short power supply line 6. It is bent back through 180°. The end 38 near to the base, a coiled section, of the light-emitting element is suspended on said end. In order to prevent the filament end 38 from sliding out, a mechanical solution is chosen here by virtue of the free end 40 of the power supply line being “thickened” in terms of diameter by virtue of it being bent to form a V-shaped wave. This technique may of course also be used for the clip 10 in order to prevent that end of the light-emitting element which is remote from the base from sliding out there.

In general terms, the halogen incandescent lamp may have a frame wire which is anchored in a tubular protuberance of the bulb, in this case in the exhaust tube, and also ends there. As an additional part for holding the light-emitting element, the frame may have a U-shaped or V-shaped or else L-shaped clip, which is fastened on the frame wire, usually with two-point welding.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A halogen incandescent lamp, comprising:
a bulb, in which a light-emitting element is fixed by means of a frame, the bulb defining an axis, the frame having a frame wire and a separate part for holding the light-emitting element,
wherein the separate part is a clip which is fastened on the frame wire, the clip having a functional limb, with the end of said functional limb being threaded or plugged into a coiled end of the light-emitting element.

2. The halogen incandescent lamp as claimed in claim 1,
wherein the clip has two limbs, which are connected to one another via a bend.

3. The halogen incandescent lamp as claimed in claim 2,
wherein the clip has two limbs, which are connected to one another via the two limbs spanning one plane.

4. The halogen incandescent lamp as claimed in claim 1,
wherein the end of the functional limb is bent back as an attachment to the limb.

5. The halogen incandescent lamp as claimed in claim 1,
wherein the bulb is coated with a reflective coating.

6. The halogen incandescent lamp as claimed in claim 5,
wherein the bulb is coated with IRC.

7. The halogen incandescent lamp as claimed in claim 1,
wherein the attachment protrudes beyond the end of the light-emitting element.

8. The halogen incandescent lamp as claimed in claim 7,
wherein the attachment has a thicker diameter than the end of the light-emitting element.

9. The halogen incandescent lamp as claimed in claim 1,
wherein the clip is fastened on the frame wire at two points.

10. The halogen incandescent lamp as claimed in claim 1,
wherein the clip is manufactured from a material with getter effect.

11. The halogen incandescent lamp as claimed in claim 10,
wherein the clip is manufactured from a Ta-containing or Nb-containing material.

12. The halogen incandescent lamp as claimed in claim 1,
wherein the clip is manufactured from a high-melting material, which deforms more easily or has higher ductility than the frame wire.

13. The halogen incandescent lamp as claimed in claim 12,
wherein the clip is manufactured from tungsten or molybdenum.

14. The halogen incandescent lamp as claimed in claim 1,
wherein, given different lamp powers, the diameter of the clip is matched to the inner diameter of the coiled end of the light-emitting element.

15. The halogen incandescent lamp as claimed in claim 1,
wherein the frame wire has a section which runs at an angle with respect to the axis and on which the clip is fastened.

16. The halogen incandescent lamp as claimed in claim 1,
wherein that end of the frame wire which is remote from the base is formed from a separate part, which is anchored in the exhaust tip.

17. The halogen incandescent lamp as claimed in claim 6, wherein the bulb coated with IRC is provided with an envelope consisting of soft glass.

18. The halogen incandescent lamp as claimed in claim 1,
wherein the bulb is provided with a base.

19. The halogen incandescent lamp as claimed in claim 6,
wherein the bulb coated with IRC is fixed in a ceramic holder.
